(19) United States
(12) Patent Application Publication
(10) Pub. No.: US 2023/0139609 A1
(43) Pub. Date: May 4, 2023

(54) ADJUSTABLE INCLUDED ANGLE OF ROTATABLE SHAFT ASSEMBLY AND TERMINAL DEVICE

(71) Applicants: Futaijing Precision Electronics (Yantai) Co., Ltd., Yantai (CN); HON HAI PRECISION INDUSTRY CO., LTD., New Taipei (CN)

(72) Inventors: WEN-BIN HUANG, New Taipei (TW); YI-REN FANG, New Taipei (TW); YI-LUN WEI, New Taipei (TW); HSIU-FU LI, New Taipei (TW)

(21) Appl. No.: 17/872,146

(22) Filed: Jul. 25, 2022

(30) Foreign Application Priority Data
Oct. 29, 2021 (CN) 202111272043.1

(51) Int. Cl. G02B 27/01; G02C 5/22

(52) U.S. Cl. CPC G02B 27/0176; G02C 5/2209; G02B 2027/0178

(57) ABSTRACT

A rotatable shaft assembly suitable for hinge of temple arm of spectacles, lockable by spring pressure at the included angle preferred for different head sizes includes a rotating shaft, a first connecting member, a second connecting member, and an elastic member. The first connecting member includes a rotating barrel and a sliding portion connected to the rotating barrel, and the rotating shaft is rotatably disposed in the rotating barrel. The second connecting member defines an accommodating groove, the sliding portion is movably accommodated in the accommodating groove. The elastic member is connected to the first connecting member and the second connecting member. A terminal device in spectacles form is also provided.

### FIELD

The subject matter herein generally relates to mechanical structures, and more particularly, to a shaft assembly and a terminal device including the shaft assembly.

### BACKGROUND

A head-worn terminal device in the form of spectacles is usually mass-produced, and it is difficult to apply to users with different head sizes. For example, the same device may be too tight or too loose for different users, thus reducing a scope of application. Therefore, there is a room for improvement in the art.

### BRIEF DESCRIPTION OF THE DRAWINGS

Implementations of the present technology will now be described, by way of example only, with reference to the attached figures.

FIG. 1 is a is a diagrammatic view of an embodiment of part of a terminal device to be worn on the head like spectacles, including shaft assembly, according to the present disclosure.

FIG. 2 is an enlarged view of area II of FIG. 1.

FIG. 3 is a diagrammatic view of a separation of a covering body from other components in a shaft assembly according to the present disclosure.

FIG. 4 is an exploded view of the shaft assembly of FIG. 3.

FIG. 5 is similar to FIG. 4, but showing the shaft assembly from another angle.

FIG. 6 is a diagrammatic view of the shaft assembly of FIG. 3 when an elastic member of the shaft assembly is undeformed.

FIG. 7 is a diagrammatic view of the shaft assembly of FIG. 3 when an elastic member of the shaft assembly is deformed.

FIG. 8 is a diagrammatic view of the device of FIG. 1 when an elastic member of the shaft assembly is undeformed.

FIG. 9 is a partial cross-sectional view of the device in FIG. 8.

FIG. 10 is a is a diagrammatic view of an included angle between a frame and a temple is a first included angle.

FIG. 11 is a partial cross-sectional view of the device in FIG. 10.

FIG. 12 is a diagrammatic view of an abutting portion of the temple rotated relative to the blocking portion, the included angle between the glasses frame and the temple being thereby a second included angle.

FIG. 13 is a partial cross-sectional view of the device in FIG. 12.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

Some embodiments of the present disclosure will be described in detail with reference to the drawings. If no conflict, the following embodiments and features in the embodiments can be combined with each other.

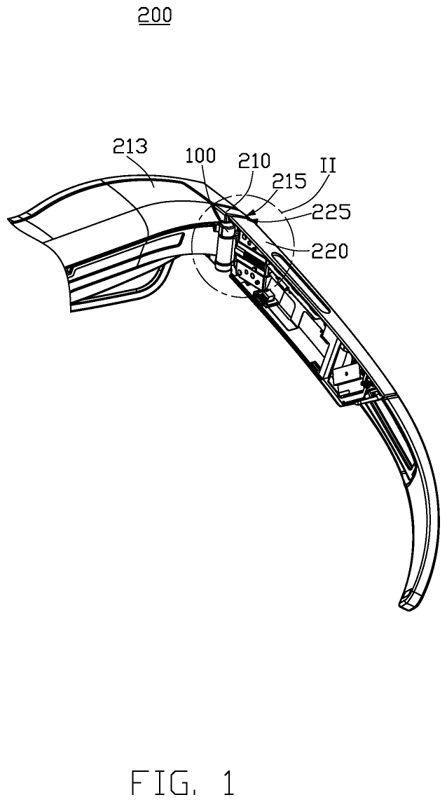

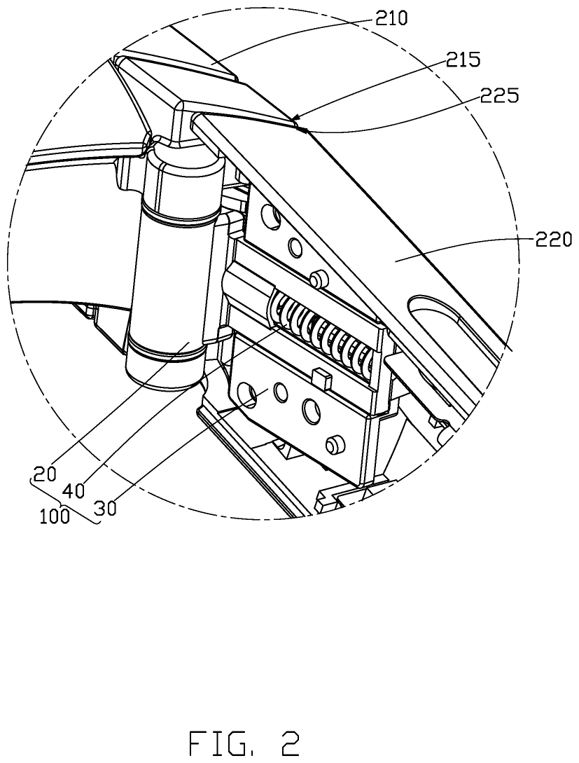

Referring to FIGS. 1, and 2, a terminal device 200 is provided according to an embodiment in the present disclosure. The terminal device 200 includes a first clamping member 210, a second clamping member 220, and a shaft assembly 100. The shaft assembly 100 is movably connected to the first clamping member 210 and the second clamping member 220, so as to adjust angles of opening and closing between the first clamping member 210 and the second clamping member 220.

The terminal device 200 (hereinafter referred to generally as “spectacles”) may be simple spectacles for vision assistance or may include but not be limited to myopia glasses, hyperopia glasses, sunglasses, smart glasses, and the like.

The spectacles include an eyeglass frame 210 (that is the first clamping member 210), a temple 220 (that is the second clamping member 220), and the shaft assembly 100 connecting the eyeglass frame 210 and the temple 220. The angle between the temple 220 and the glasses frame 210 can be adjusted through the shaft assembly 100.

In some embodiments, the first clamping member 210 further includes an optical machine module 213, and the optical machine module 213 is fixedly connected to the eyeglass frame 210.

The side of the eyeglass frame 210 facing the temple 220 has a blocking portion 215. The side of the temple 220 facing the eyeglass frame 210 has an abutting portion 225. When the spectacles are to be used, the temple 220 can rotate relative to the glasses frame 210, and the abutting portion 225 abuts the blocking portion 215, so that the temple 220 has a fixed angle relative to the glasses frame 210 for the convenience of the user.

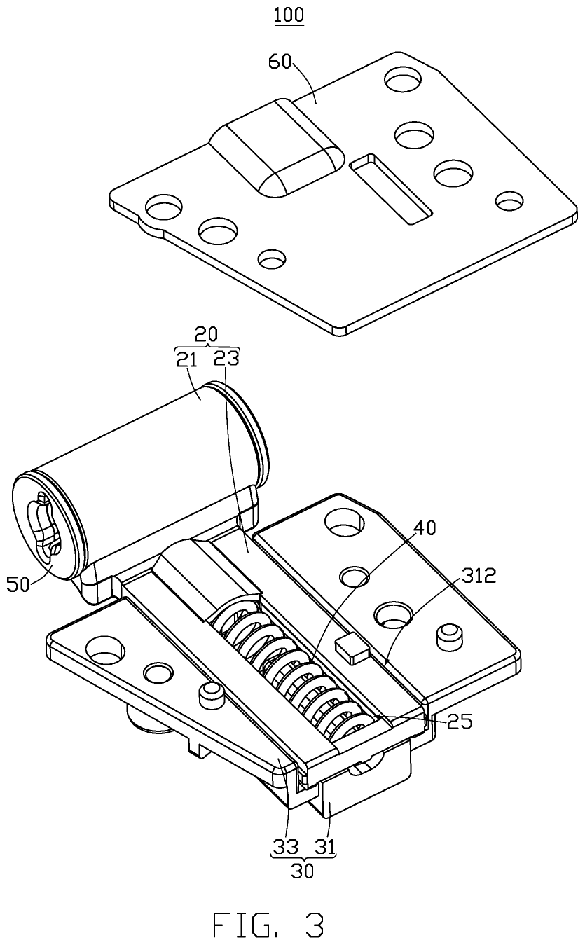

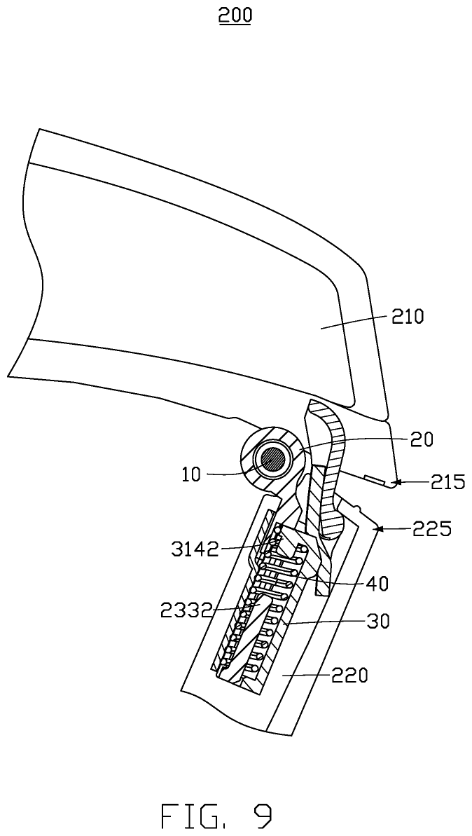

Referring to FIGS. 3, 4, and 5, the shaft assembly 100 includes a rotating shaft 10 (also referring to FIG. 9), a first connecting member 20, a second connecting member 30, and an elastic member 40. The rotating shaft 10 is fixedly connected to the glasses frame 210, and the rotating shaft 10 is rotatably connected to the first connecting member 20, so that the glasses frame 210 can be rotatably connected to the shaft assembly 100. The elastic member 40 is connected to the first connecting member 20 and the second connecting member 30. The second connecting member 30 is fixedly connected to the temple 220. The maximum angle of opening of the temple 220 and the glasses frame 210 can be adjusted through the shaft assembly 100.

In other embodiments, the manner of connection of the glasses frame 210, the temple 220 and the shaft assembly 100 can be interchanged, that is, the glasses frame 210 can be connected to the second connecting member 30, and the temple 220 can be connected to the first connecting member 20.

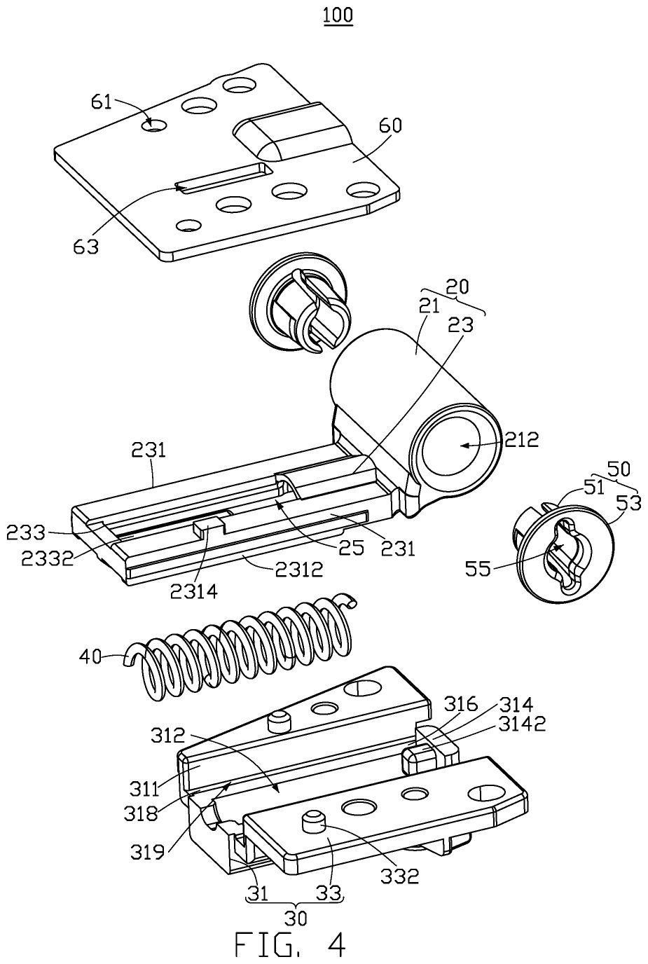

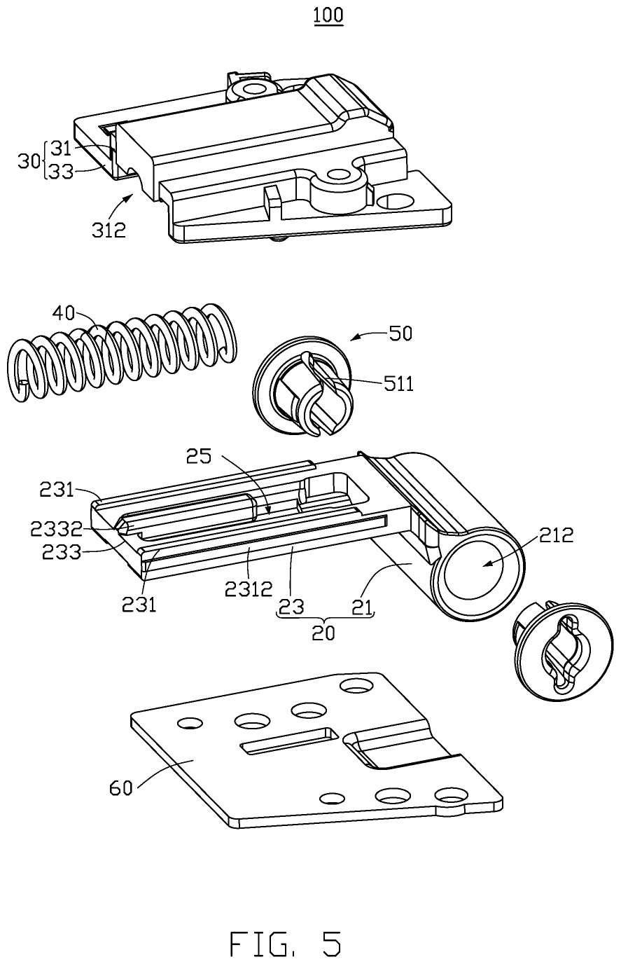

Referring to FIGS. 4 and 5, the first connecting member 20 includes a rotating barrel 21 and a sliding portion 23 connected to the rotating barrel 21. The rotating barrel 21 and the sliding portion 23 are integrally formed. The rotating barrel 21 is a hollow cylindrical body, openings 212 are defined in both ends of the rotating barrel 21. The opening 212 is used for accommodating the rotating shaft 10. The sliding portion 23 is formed by extending from an outer wall of the rotating barrel 21. The sliding portion 23 is frame-like. The sliding portion 23 includes two first rod portions 231 disposed opposite to each other and a second rod portion 233 connected to the two first rod portions 231 and disposed away from the rotating barrel 21. A first fixing column 2332 extends from the second rod portion 233 toward the rotating barrel 21.

The rotating shaft 10 is accommodated in the rotating barrel 21 from the opening 212 and inserted into the rotating barrel 21 through the opening 212. The rotating shaft 10 is fixedly connected to the blocking portion 215 of the temple 220 and is rotatably connected to the rotating shaft 10. The rotating barrel 21 is adjacent to the blocking portion 215, and the sliding portion 23 is disposed on a side of the rotating barrel 21 away from the blocking portion 215. The rotating barrel 21 is rotatably connected to the glasses frame 210 through the rotating shaft 10 and drives the sliding portion 23 to rotate relative to the glasses frame 210.

The rotating shaft 10 and the rotating barrel 21 may also be connected by a flange 50, the flange 50 acts to increase an amount of damping between the rotating shaft 10 and the rotating barrel 21.

Referring to FIGS. 4 and 5, the flange 50 includes an extending portion 51 and a protruding portion 53 fixedly connected to the extending portion 51. The protruding portion 53 is substantially a hollow body. A diameter of the protruding portion 53 is larger than that of the opening 212, and a diameter of the opening 212 is larger than that of the extending portion 51, so that the extending portion 51 is accommodated in the rotating barrel 21 from the opening 212. The protruding portion 53 is exposed through the opening 212. An outer periphery of the extending portion 51 is provided with a clamping structure 511 adapted to the rotating barrel 21. Each rotating shaft 10 is assembled in the rotating barrel 21 through the opening 212 and is fixedly connected to the rotating barrel 21 through the clamping structure 511. The flange 50 is defined with a second through hole 55, the second through hole 55 penetrates the extending portion 51 and the protruding portion 53, and the second through hole 55 penetrates the rotating shaft 10 through the flange 50. The clamping structure 511 is an opening defined along a longitudinal direction of the protruding portion 53 and/or a protrusion disposed along a longitudinal direction of the protruding portion 53, and an inner wall of the rotating barrel 21 is provided with a structure adapted to the protruding portion 53, so that the flange 50 is fixedly connected to the rotating barrel 21.

Referring to FIGS. 4, and 5, the second connecting member 30 includes an accommodating portion 31 and a fixing portion 33. The fixing portion 33 is disposed on both sides of the accommodating portion 31 and extends outward.

The fixing portion 33 fixes the second connecting member 30 on the temple 220. The fixing portion 33 is provided with a positioning column 332.

The accommodating portion 31 is a block of material. The accommodating portion 31 includes a first side wall 311 connected to the fixing portion 33. An accommodating groove 312 is defined on a surface of the accommodating portion 31 facing the sliding portion 23, and the accommodating groove 312 is recessed inwards from a surface of the second connecting member 30 facing the first connecting member 20. An end wall 314 and two second side walls 316 are extended from one end and two sides of the accommodating groove 312 from the surface forming the accommodating groove 312. The second side wall 316 is connected to the first side wall 311 through a bottom wall 318. A groove 319 is defined by the second side wall 316, the bottom wall 318, and the first side wall 311 together. The first rod portion 231 is accommodated in the groove 319, each second side wall 316 is in contact with a surface of each first rod portion 231, the first rod portion 231 can slide in the groove 319. The second side wall 316 plays roles of guiding and limiting.

A second fixing column 3142 protrudes from the surface of the end wall 314 facing the accommodating groove 312, and the second fixing column 3142 is disposed with the first fixing column 2332. That is, the second fixing column 3142 extends toward the first fixing column 2332, and the first fixing column 2332 extends toward the second fixing column 3142. The ends of the elastic member 40 are detachably sleeved on the first fixing column 2332 and the second fixing column 3142. The first fixing column 2332 and the second fixing column 3142 limit a position of the elastic member 40. The elastic member 40 is detachably accommodated in the accommodating groove 312. The elastic member 40 is deformed when subjected to an external force, and recovers the deformation when the external force is removed. One end of the elastic member 40 is connected to the first fixing column 2332, and the other end of the elastic member 40 is connected to the second fixing column 3142. The elastic member 40 is deformed along a direction of the relative movement of the first connecting member 20 and the second connecting member 30. When the external force is removed, the elastic member 40 returns to the initial state. When a distance between the first fixing column 2332 and the second fixing column 3142 is gradually reduced to compress the elastic member 40, the rod portion 231 moves outside of the second side wall 316 along the second side wall 316, thereby the second side wall 316 plays a guiding role. A distance between the second rod portion 233 fixedly connected to the first fixing column 2332 and the second side wall 316 fixedly connected to the second fixing column 3142 decreases until the second rod portion 233 and the second side wall 316 contact each other. At this time, there is zero distance between the first fixing column 2332 and the second fixing column 3142, the second side wall 316 plays a limiting role.

The elastic member 40 can be deformed by tension and compression. The elastic member 40 may be a compression spring or a tension spring. In the embodiment, the elastic member 40 is a compression spring.

The relative position between the first connecting member 20 and the second connecting member 30 can be controlled by an amount of deformation of the elastic member 40. That is, the distance between the blocking portion 215 and the abutting portion 225 is controlled by the distance that the first connecting member 20 protrudes from the accommodating groove 312 of the second connecting member 30, so as to provide space for the abutting portion 225 to rotate further relative to the blocking portion 215, thereby increasing a maximum angle between the glasses frame 210 and the temples.

The juxtaposed of the two first rod portions 231, the second rod portion 233, and the rotating barrel 21 creates a first through hole 25 on the sliding portion 23. The part of the sliding portion 23 including the first through hole 25 is accommodated in the accommodating groove 312, and at least part of the elastic member 40 is exposed in the first through hole 25. The first through hole 25 facilitates replacement of the elastic member 40, and the elastic member 40 can be taken out or placed in the first through hole 25 without disassembling the first connecting member 20 and the second connecting member 30. Replacement of the elastic member 40 may follow or be required for changes in the elastic force of the elastic member 40 after long-term use or different elastic forces of the elastic member 40 needed for different users.

Reinforcing ribs 2312 are further disposed across each first rod portion 231. The reinforcing ribs 2312 are disposed on each surface of the first rod portion 231 away from the second rod portion 233. Each reinforcing rib 2312 extends on the first rod portion 231 along the movement direction of the sliding portion 23 in the accommodating groove 312. The reinforcing ribs 2312 are in permanent contact with the sliding portion 23 to increase or at least maintain a connecting force between the sliding portion 23 and the accommodating portion 31, thus the first connecting member 20 and the second connecting member 30 do not directly separate from each other.

Referring to FIG. 3 again, the shaft assembly 100 may further include a covering body 60. The covering body 60 is shaped to match in opposition the shape of the second connecting member 30. The covering body 60 is fixed with the second connecting member 30 and forms an accommodating space (not marked in figures) for accommodating the sliding portion 23. The covering body 60 and the second connecting member 30 in FIG. 3 are separated from each other, so that the structure between the covering body 60 and the second connecting member 30 can be easily checked.

Referring to FIG. 4, a positioning hole 61 is defined on the covering body 60. The positioning column 332 is inserted through the positioning hole 61 to fix and connect the covering body 60 and the second connecting member 30 to limit the sliding portion 23 and prevent the second connecting member 30 from falling off from the accommodating portion 31.

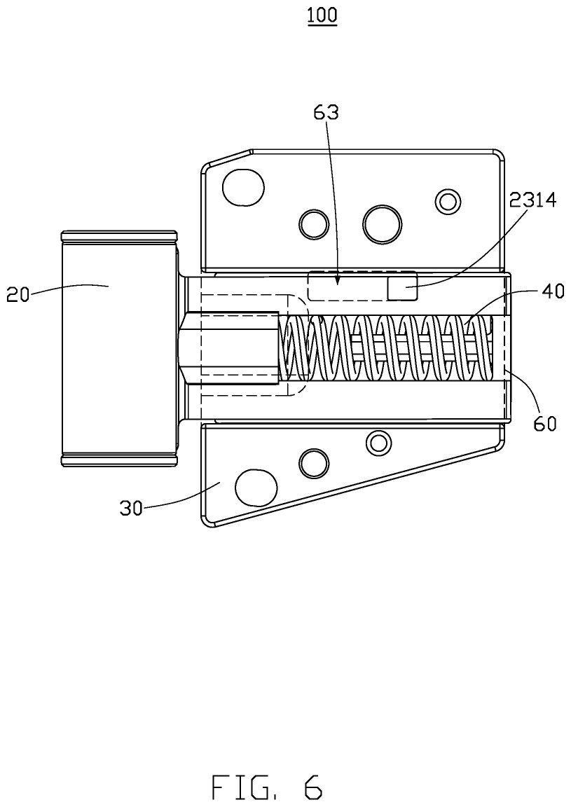

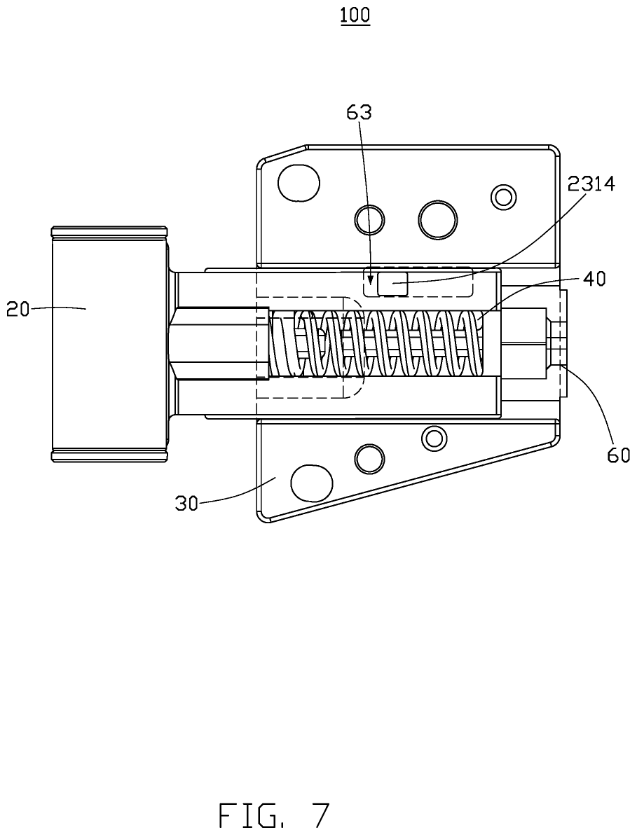

Referring to FIGS. 3, 4, and 5 again, a stopping portion 2314 is disposed on a surface of the first rod portion 231 facing the covering body 60. A blocking groove 63 is disposed on the covering body 60 engaged with the stopping portion 2314. An extending direction of the blocking groove 63 is the same as an extending direction of the groove 319. The stopping portion 2314 is slidably accommodated in the blocking groove 63. The stopping portion 2314 and the blocking groove 63 cooperate with each other to limit the relative sliding distance between the first connecting member 20 and the covering body 60, thereby controlling the amount of deformation of the elastic member 40, thereby controlling an included angle between the temple 220 and the glasses frame 210. Referring to FIGS. 6, and 7, FIG. 6 shows a state when the first connecting member 20 and the covering body 60 do not slide against each other, that is, the elastic member 40 is not compressed. At the time, the temple 220 has no clamping force. FIG. 7 shows a state when the first connecting member 20 and the covering body 60 slide against each other and the elastic member 40 is compressed. At the time, the temple 220 is subjected to a clamping force.

The following describes in detail the process of the spectacles with adjustable angles of opening and closing provided by the embodiment.

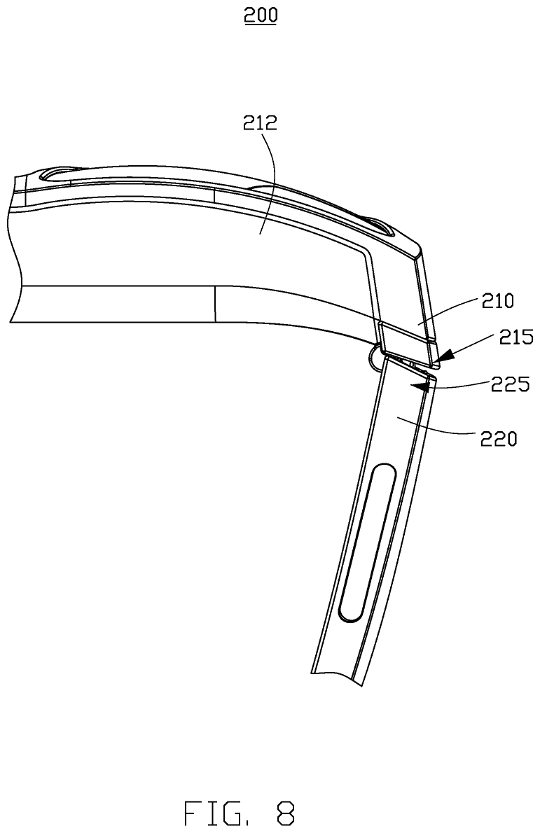

Referring to FIGS. 8, and 9, during an opening process of the spectacles, the temple 220 is rotated relative to the glasses frame 210, the abutting portion 225 of the temple 220 does not abut against the blocking portion 215 of the glasses frame 210, and the elastic member 40 is undeformed.

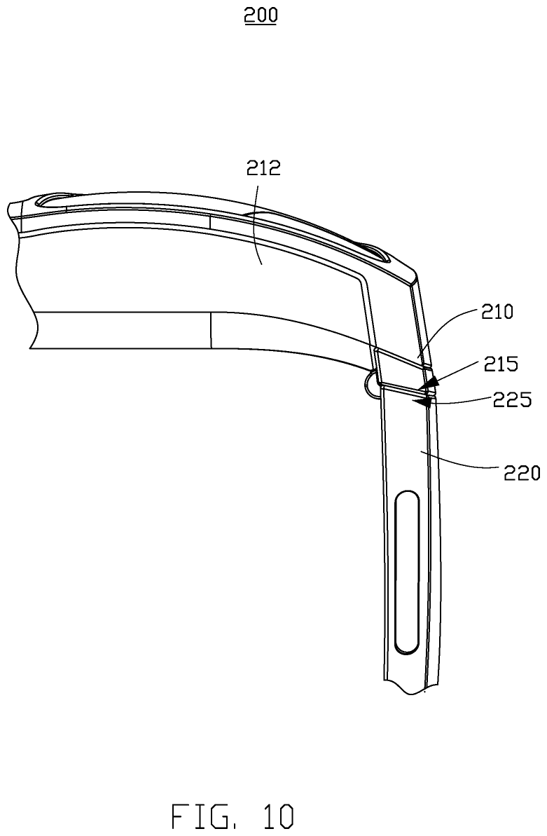

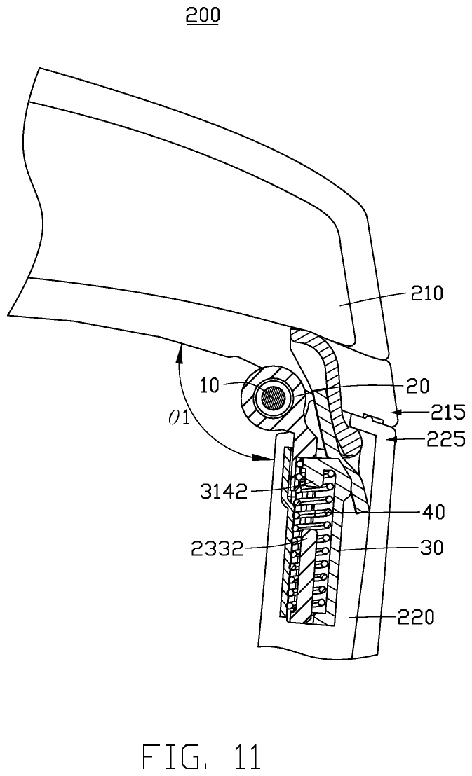

Referring to FIGS. 10, and 11, rotation of the temple 220 is continued so that the abutting portion 225 of the temple 220 abuts against the blocking portion 215 of the eyeglass frame 210. At this time, the elastic member 40 is undeformed, and a largest included angle between the temple 220 and the glasses frame 210 is defined as first included angle θ1.

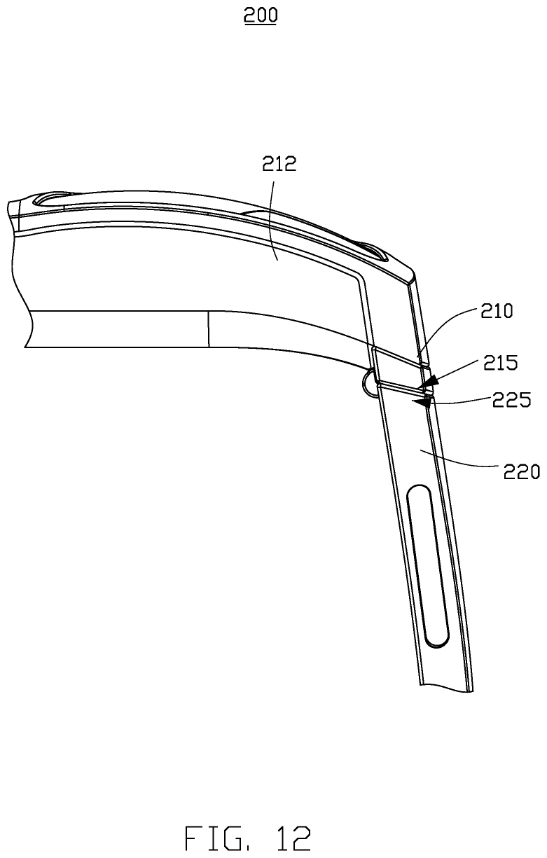

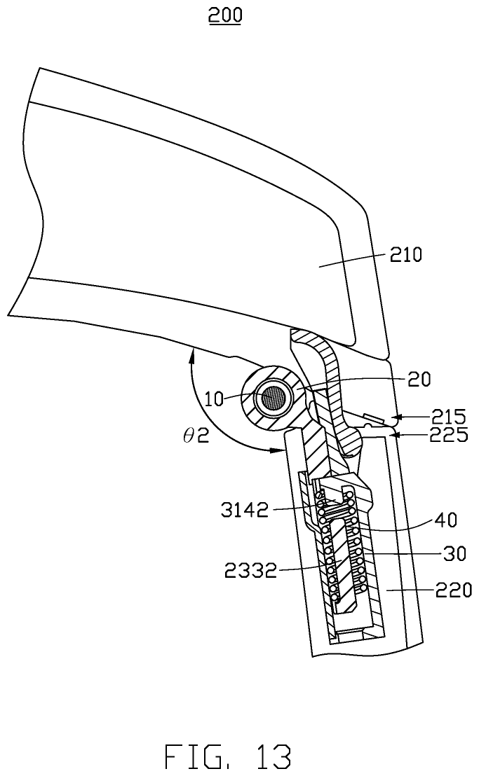

Referring to FIGS. 12, and 13, when user requires a different first included angle 01, rotation of the temple 220 is continued to rotate the first connector 20 relative to the eyeglass frame 210, so that the abutting portion 225 and the blocking portion 215 rotate relative to each other. At the time, the sliding portion 23 slides in the groove 319, the distance between the first fixing column 2332 and the second fixing column 3142 is reduced, and the elastic member 40 is deformed. The included angle between the temple 220 and the glasses frame 210 is now the second included angle θ2, and the second included angle θ2 is greater than the first included angle θ1. When the elastic member 40 is deformed, the range of included angles between the eyeglass frame 210 and the temple 220 can be adjusted according to the deformation amount of the elastic member 40 and the maximum sliding range of the blocking portion 215 in the blocking groove 63. When the included angle between the temple 220 and the glasses frame 210 is within the range of included angles between the first included angle θ1 and the second included angle θ2, the elastic member 40 is deformed. A clamping force is present between the temple 220 and the glasses frame 210 due to the elastic deformation restoring force of the elastic member 40, so as to facilitate comfort in use by the user.

The included angle θ1 and the second included angle θ2 can be set according to user requirements. In the embodiment, when the elastic member 40 does not deform, the range of included angle between the glasses frame 210 and the temple 220 ranges from 0° to 90°, that is, the first included angle θ1 is 90°. When the elastic member 40 is deformed, the included angle between the glasses frame 210 and the temple 220 ranges from 90° to 125°, that is, the second included angle θ2 is 125°. The included angle between the glasses frame 210 and the temple 220 is thus 125°. Therefore, the included angle between the glasses frame 210 and the temple 220 ranges from 0° to 125°.

When the shaft assembly 100 provided in the present disclosure is applied to the terminal device 200, the first clamping member 210 and the second clamping member 220 are connected through the shaft assembly 100. The deformable elastic member 40 is disposed in the shaft assembly 100, and the elastic member 40 deforms to change the relative position of the first connecting member 20 and the second connecting member 30. Thus, the relative positions between the first clamping member 210 and the second clamping member 220 connected to the first connecting member 20 and the second connecting member 30 are changed. Therefore, the space for rotation between the blocking portion 215 and the abutting portion 225 is affected, and the angles of opening and closing between the first clamping member 210 and the second clamping member 220 are adjusted.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A shaft assembly comprising:
a rotating shaft;
a first connecting member comprising a rotating barrel and a sliding portion connected to the rotating barrel, and the rotating shaft rotatably disposed in the rotating barrel;
a second connecting member defining an accommodating groove, the sliding portion movably accommodated in the accommodating groove; and
an elastic member, elastically connecting the first connecting member and the second connecting member.

2. The shaft assembly of claim 1, wherein the shaft barrel comprises at least one opening, the rotating shaft is disposed at least partially in the opening and is rotatably connected with the rotating barrel.

3. The shaft assembly of claim 2, the shaft assembly further comprising a flange, wherein the flange is defined with a second through hole, at least a part of the flange is accommodated in the opening and is fixedly connected to the rotating barrel, and the rotating shaft passes through the second through hole and is rotatably connected to the flange.

4. The shaft assembly of claim 3, wherein the flange comprises an extending portion and a protruding portion fixedly connected to the extending portion, the extending portion is accommodated in the rotating barrel from the opening, the protruding portion is exposed from the opening, and the second through hole penetrates the extending portion and the protruding portion.

5. The shaft assembly of claim 1, wherein the sliding portion comprises two first rod portions disposed opposite to each other, and a second rod portion connected to the two first rod portions and disposed away from the rotating barrel; a first fixing column extends from the second rod portion toward the rotating barrel.

6. The shaft assembly of claim 5, wherein the second connecting member comprises an accommodating portion and a fixing portion, the fixing portion is disposed on both sides of the accommodating portion and extends outward; the fixing portion is provided with a positioning column.

7. The shaft assembly of claim 6, wherein the second connecting member comprises a first side wall and a bottom wall, the first side wall is connected to the fixing portion, and the bottom wall is connected to the first side wall.

8. The shaft assembly of claim 7, wherein the accommodating portion comprises the accommodating groove, the accommodating portion further comprises two second side walls, the second side wall is formed by extending from a surface of the accommodating groove, and the second side wall is in contact with a surface of the first rod portion.

9. The shaft assembly of claim 8, wherein the second side wall is connected to the bottom wall; a groove is defined by the second side wall, the bottom wall, and the first side wall together; the first rod is slidably disposed in the groove.

10. The shaft assembly of claim 8, wherein the accommodating portion further comprises an end wall, the end wall is formed by extending from a surface of the accommodating groove and is disposed between the two second side walls, and a surface of the end wall facing the accommodating groove is protruded with a second fixing column.

11. The shaft assembly of claim 10, wherein one end of the elastic member is detachably connected to the first fixing column, and the other end of the elastic member is detachably connected to the second fixing column.

12. The shaft assembly of claim 5, wherein a first through hole is formed around the first rod portion, the second rod portion, and the rotating barrel; and the elastic member is exposed to the first through hole.

13. The shaft assembly of claim 12, wherein a reinforcing rib is disposed on each first rod portion adjacent to the accommodating groove.

14. The shaft assembly of claim 5, the shaft assembly further comprising a covering body, wherein the covering body is fixed with the second connecting member, the sliding portion is disposed between the covering body and the second connecting member.

15. The shaft assembly of claim 14, wherein the cover body is defined with a positioning hole, and the positioning column is passed through the positioning hole.

16. The shaft assembly of claim 14, wherein a stopping portion is disposed on a surface of the first rod portion facing the covering body, a blocking groove is disposed on the covering body engaged with the stopping portion, the stopping portion is slidably accommodated in the blocking groove.

17. A terminal device comprising:
a first clamping member;
a second clamping member; and
a shaft assembly comprising:
a rotating shaft;
a first connecting member comprising a rotating barrel and a sliding portion connected to the rotating barrel, and the rotating shaft rotatably disposed in the rotating barrel;
a second connecting member defining an accommodating groove, the sliding portion movably accommodated in the accommodating groove; and
an elastic member, elastically connecting the first connecting member and the second connecting member;
wherein the rotating shaft rotates relative to the abutting portion until the abutting portion abuts on the blocking portion; when the elastic member is deformed, the abutting portion and the blocking portion rotate relative to each other, thereby adjusting angles of opening and closing between the first clamping member and the second clamping member.

18. The terminal device of claim 17, wherein when the elastic member is undeformed, an included angle between the first clamping member and the second clamping member ranges from 0° to a first included angle; when the elastic member is deformed, the included angle between the first clamping member and the second clamping member ranges from the first included angle to a second included angle; the second included angle is greater than the first included angle.

19. The terminal device of claim 17, wherein the terminal device is spectacles, the first clamping member is an eyeglass frame, and the second clamping member is a temple.

20. The terminal device of claim 19, wherein the first clamping member further comprises an optical machine module fixedly connected to the eyeglass frame.
